(19) United States
(12) Patent Application Publication
(10) Pub. No.: US 2024/0145151 A1
(43) Pub. Date: May 2, 2024

(54) COIL COMPONENT, CORE MEMBER, CORE COMPONENT, AND ELECTRONIC COMPONENT

(71) Applicant: TDK CORPORATION, Tokyo (JP)

(72) Inventors: Masayoshi SHIMAZAKI, Tokyo (JP); Osamu OHHATA, Tokyo (JP); Naoto TSUKAMOTO, Tokyo (JP); Sena YOSHINO, Tokyo (JP); Nobuo KITAJIMA, Tokyo (JP); Masashi GOTOH, Tokyo (JP)

(73) Assignee: TDK CORPORATION, Tokyo (JP)

(21) Appl. No.: 18/498,131

(22) Filed: Oct. 31, 2023

(30) Foreign Application Priority Data
Oct. 31, 2022 (JP) 2022-174931

(51) Int. Cl. H01F 17/04; H01F 27/24; H01F 27/28

(52) U.S. Cl. CPC H01F 17/04; H01F 27/24; H01F 27/2823

(57) ABSTRACT

Provided is a coil component including a core member and a wire wound around the core member, wherein a cross section of the core member perpendicular to a winding axis of the wire wound around the core member has a circumference shape comprising at least three first arcs and connecting lines connecting the at least three first arcs adjacent to each other, and each of the at least three first arcs has a predetermined radius and a predetermined central angle for closely contacting the wire and the core member.

This application claims priority to Japanese patent application No. 2022-174931 filed on Oct. 31, 2022 which is incorporated herein by reference in its entirety.

### BACKGROUND

The present disclosure relates to a coil component having a wire wound around a core member, an electronic component having an arbitrary electronic element arranged around the core member, the core member, and a core component including the core member.

Electronic components such as a coil inductor including a coil part which is made by winding a conductive wire around a core such as ferrite is used in various electronic devices (for example, see Patent Document 1). As a shape of the core, a cuboid shape, a cylindrical shape, a hexagonal prism shape, and so on are known.

[Patent Document 1] Japanese Patent Application Laid-Open No. H10-294232

### SUMMARY

The coil component according to one aspect of the present disclosure includes a core member and a wire wound around the core member, wherein
a cross section of the core member perpendicular to a winding axis of the wire wound around the core member has a circumference shape which includes at least three first arcs and connecting lines connecting the at least three first arcs adjacent to each other, and
each of the at least three first arcs has a predetermined radius and a predetermined central angle for closely contacting the wire and the core member.

Also, a core member according to one aspect of the present disclosure is a core member to which a wire is wound around, wherein
the core member has a shape that a circumference of a cross section of the core member includes
second arcs in pairs which are opposite to each other along one axis of two axes perpendicular to each other,
third arcs in pairs which are opposite to each other along an other axis of the two axes perpendicular to each other, and
four of first arcs which each of these is arranged between one of the second arcs and one of the third arcs, in which a direction extending to connect a mid-point and a center point of each of the first arcs forms 45° with each axis of the two axes perpendicular to each other, and the first arcs are tangentially connected to the second arcs and the third arcs.

Also, a core component according to one aspect of the present disclosure includes a flange (brim) portion installed to both sides of the core member in an axis direction perpendicular to a cross section of the core member.

An electronic component according to one aspect of the present disclosure includes the above-mentioned core member.

### BRIEF DESCRIPTION OF DRAWINGS

FIG. 1A is a perspective diagram showing one example of overall configuration of a coil component according to one embodiment of the present disclosure.

FIG. 1B is a perspective diagram showing configuration of a drum core of the coil component shown in FIG. 1A.

FIG. 1C is a perspective diagram showing a part of the winding core part of a drum core in the coil component shown in FIG. 1A.

FIG. 2A is a cross-sectional diagram showing the state that the wire being wound around the winding core part of the drum core in the coil component shown in FIG. 1A.

FIG. 2B is a cross-sectional diagram showing the state that the wire being wound around the winding core part of the drum core in a coil component according to a first modified example of the present disclosure.

FIG. 2C is a cross-sectional diagram showing the state that the wire being wound around the winding core part of the drum core in a coil component according to a second modified example of the present disclosure.

FIG. 3 is a diagram explaining an example of a cross-sectional shape of a core member according to an embodiment of the present disclosure.

FIG. 4A is a first diagram explaining properties of the wire necessary for determining a cross-sectional shape of the core member according to an embodiment of the present disclosure.

FIG. 4B is a second diagram explaining properties of the wire necessary for determining a cross-sectional shape of the core member according to an embodiment of the present disclosure.

FIG. 5A is a first diagram showing a comparative example, and it is a cross-sectional diagram showing a coil part in which the wire is wound around the core member of a rectangular cross-sectional shape.

FIG. 5B is a second diagram showing a comparative example, and it is a cross-sectional diagram showing a coil part in which the wire is wound around the core member of a hexagonal cross-sectional shape.

FIG. 5C is a cross-sectional diagram showing the coil part in which the wire is wound around the core member according to one embodiment of the present disclosure.

FIG. 6 is a diagram showing DC superimposition characteristics of the coil component including the coil parts shown in FIG. 5A to FIG. 5C.

### DETAILED DESCRIPTION

In below, an embodiment of the present disclosure is described using the figures. The below described embodiment of the present disclosure is an example for explaining the present disclosure. For example, numerical values, shapes, materials, production steps, and so on may be modified and changed within the range which does not cause technical problems.

Also, the shapes and so on shown in the figures of the present disclosure are not necessarily the accurate representation of the actual shapes and so on. The shapes and so on may be modified in some embodiments for explanation.

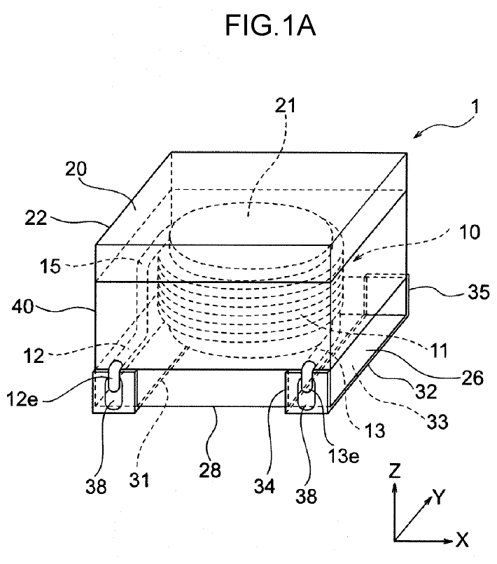

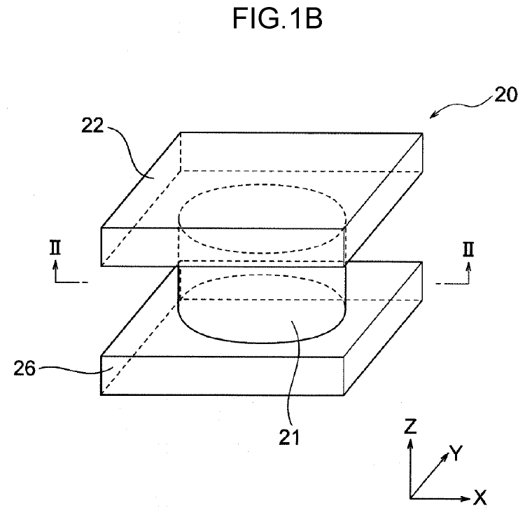

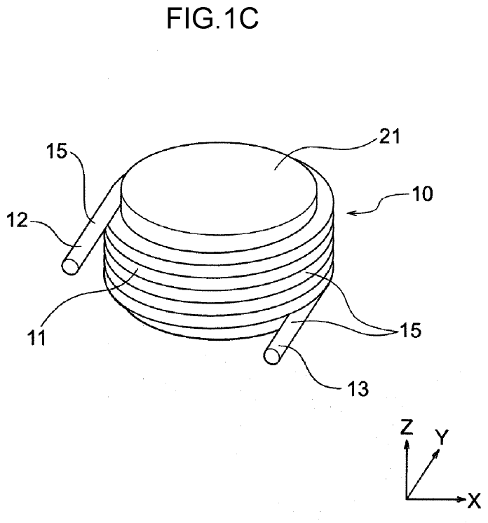

A coil component 1 according to an embodiment of the present disclosure shown in FIG. 1A may be an inductor which is, for example, used as a choke coil, a noise filter, and so on.

The coil component 1 includes a coil part 10, a drum core 20, terminal electrodes 31 and 32, and an encapsulation resin 40.

As shown in FIG. 1A and FIG. 1C, the coil part 10 includes a wire wound part 11 which a part of a wire 15 being wound along a circumference of a core member 21 of the drum core 20, a first lead 12 and a second lead 13 which are both ends of the wire 15 extending from the wire wound part 11. As shown in FIG. 1A, an end part 12e of the first lead 12 and an end part 13e of the second lead 13 are respectively connected to the first electrode 31 (terminal electrode) and the second electrode 32 (terminal electrode).

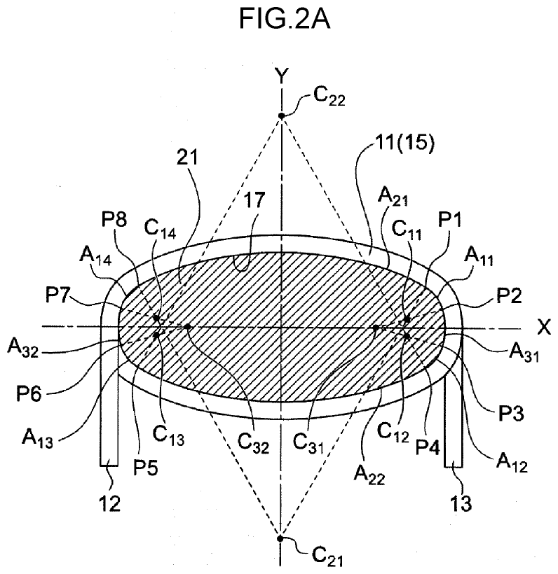

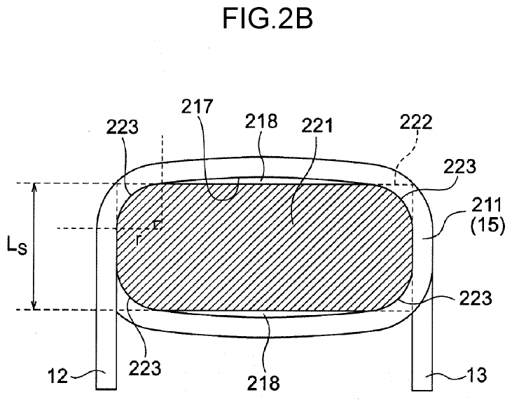

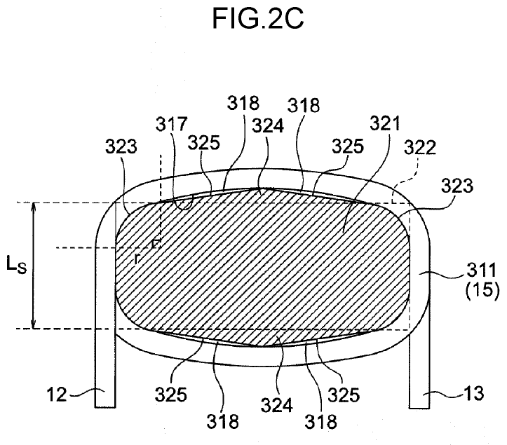

In the coil component 1 of the present disclosure, a parameter representing easiness of bending of the wire 15 when it is wound around the winding core part (core member) 21 of the drum core 20 is measured in advance, and based on this parameter, the cross-sectional shape of the winding core part 21 of the drum core is designed and defined as shown in FIG. 2A. Thus, in the coil part 10 of the present disclosure, the wire 15 is wound around the winding core part 21 of the drum core with substantially no gap between the wire and the winding core part 21. Conditions for winding the wire 15 around the winding core part 21, the parameter representing the easiness of bending of the wire 15, and the cross-sectional shape of the winding core part 21 are described in below.

As the wire 15, it is not particularly limited, and for example, a conductive wire such as a flat wire, a round wire, a stranded wire, a litz wire, or a braided wire which is, for example, made of copper may be used. Alternatively, a wire which is made by applying insulation coating to the conductive wire may be used. Specifically, any known wires such as AIW (polyimide wire), UEW (polyurethane wire), UEW, USTC, and so on may be used. A size of the wire 15 is not particularly limited, and for example, in the case of the round wire, it may be within a range of 5 μm to 2 mm, or within a range of 10 μm to 1 mm. In the case of the flat wire, the size of the wire may be a thickness within a range of 10 μm to 2.5 mm and a width within a range of 100 μm to 1 mm.

Also, the coil part 10 of the coil component 1 according to the present embodiment is a coil of which the wire 15 is wound in a generally used normal wise, but a winding method of the wire is not limited thereto. For example, the wire 15 may be wound using a α-winding method, a flat winding method, or an edgewise winding method. Also, the number of windings of the wire 15 is not particularly limited. Also, in the present embodiment, one wire 15 is used for winding and forms the wire wound part 11, however, two or more wires 15 may be used to form the wire wound part 11 by winding the wires around the winding core part 21.

As shown in FIG. 1A and FIG. 1B, the drum core 20 includes the winding core part (core member) 21 where the wire 15 is wound, and a first flange (brim) 22 and a second flange (brim) 26 at the both end parts along the winding axis direction (Z-axis direction) of the winding core part 21.

The winding core part 21 is a columnar member of which a cross section perpendicular to the winding axis of the wire 15 has a predetermined cross-sectional shape as shown in FIG. 2A. The cross-sectional shape of the winding core part 21 is designed and defined based on a size of the coil component 1 (a cross-sectional size of the winding core part 21), winding conditions of the wire 15 to the winding core part 21, and the parameter representing the easiness of bending of the wire 15 under the conditions; and for example, the cross-sectional shape of the winding core part 21 has a shape shown in FIG. 2A.

The cross section of the winding core part 21 shown in FIG. 2A has a circumference shape of which four first arcs A11 to A14, two second arcs A21 and A22, and two third arcs A31 and A32 are smoothly connected in sequence. More specifically, the circumference shape of the cross section of the winding core part 21 has the two second arcs A21 and A22 arranged in a way opposing to each other along Y-axis, and the two third arcs A31 and A32 arranged in a way opposing to each other along X-axis. The four first arcs A11 to A14 are arranged between the second arcs and the third arcs so as to connect these.

In the present embodiment, shapes and so on of each part of the coil component will be described using a coordinate system defined by X-axis, Y-axis, and Z-axis; in which X-axis, Y-axis, and Z-axis are perpendicular to each other, Z-axis matches the winding axis of the wire wound part 11 of the coil part and also a center axis of the winding core part (core member) 21 of the drum core, and a X-Y plane is a plane perpendicular to the winding axis of the wire wound part 11 of the coil part and parallel to a cross section of the winding core part (core member) 21 of the drum core.

The first arcs A11 to A14 are arcs which respectively have arc centers C11 to C14, and have predetermined radii and predetermined central angles. The second arcs A21 and A22 are arcs which respectively have arc centers C21 and C22, and have predetermined radii and predetermined central angles. The third arcs A31 and A32 are arcs which respectively have arc centers C31 and C32, and have predetermined radii and predetermined central angles.

The centers C21 and C22 of the second arcs A21 and A22 are arranged on Y-axis. The centers C31 and C32 of the third arcs A31 and A32 are arranged on X-axis. The straight lines connecting mid-points and the centers C11 to C14 of the first arcs A11 to A14 are arranged on straight lines which form 45° with each of X-axis and Y-axis. Also, in all cases of the first to third arcs A11 to A14, A21, A22, A31, and A32, chords of these arcs are facing the origin point, and the circumference shape of the cross section of the winding core part 21 has a protruding shape.

These eight arcs which are the first to third arcs A11 to A14, A21, A22, A31, and A32 are connected smoothly in sequence at connecting points P1 to P8, and in the present embodiment, each of these eight arcs is tangentially connected at the connecting points P1 to P8. Here, “tangentially” means that tangent lines at a connecting point of adjacent arcs are the same, and when two arcs are tangentially connected, three points, which are the centers of two arcs and the connecting point, are on one straight line.

In the winding core part 21 shown in FIG. 2A, for example, regarding the connection of the first arc A11 and the second arc A21, the three points, which are the center C11 of the first arc A11, the center C21 of the second arc A21, and the connecting point P1 connecting the first arc A11 and the second arc A21, are aligned on one straight line as shown in the figure. Also, a straight line which perpendicularly intercepts with the one straight line is the tangent line at the connecting point P1 of each of the first arc A11 and the second arc A21, and a tangent line of the first arc A11 at P1 and a tangent line of the second arc A21 at P1 are the same. Also, for example, regarding the connection of the first arc A11 and the third arc A31, the center C11 of the first arc A11, the center C31 of the third arc A31, and the connecting point P2 connecting the first arc A11 and the third arc A31, these three points are aligned on one straight line as shown in the figure. Also, a straight line which perpendicularly intercepts with the one straight line is the tangent line at the connecting point P2 of each of the first arc A11 and the third arc A31, and a tangent line of the first arc A11 at P2 and the tangent line of the second arc A21 at P2 are the same. As such, the adjacent arcs are tangentially connected, and the arcs are connected sequentially in such manner.

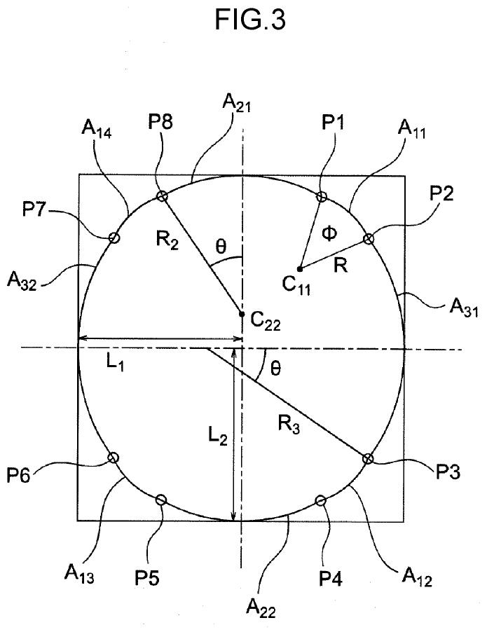

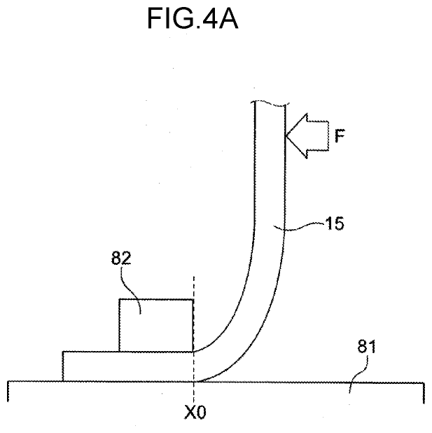

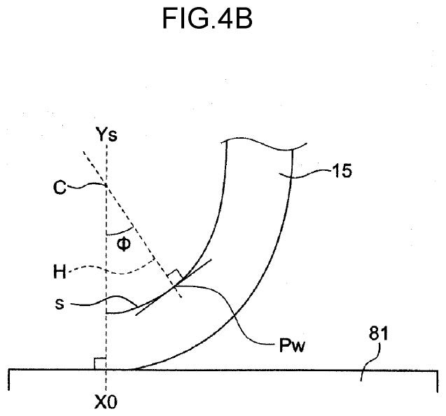

Methods of determining center positions, radii, and central angles of the first to third arcs A11 to A14, A21, A22, A31, and A32 are described using FIG. 3 and FIG. 4.

When determining the center positions and so on of the arcs, as conditions regarding a size of the cross-sectional shape of the winding core part 21, an X-axis direction length 2L1 of the winding core part 21 (that is, L1 is ½ of the X-axis direction length of the winding core part 21) and a Y-axis direction length 2L2 of the winding core part 21 (that is, L2 is ½ of the Y-axis direction length of the winding core part 21) which are shown in FIG. 3 are determined. Also, the wire 15 which is wound around the winding core part 21 is selected in advance, and load F acting in the bending direction of the selected wire 15 when it is wound around the winding core part 21 is also determined in advance.

Next, as shown in below, the parameter representing the easiness of bending of the wire 15 when winding it around the winding core part is measured using load F and the wire actually used for winding.

First, as shown in FIG. 4A, the wire 15 is placed on a horizontal workbench 81, a portion of the wire 15 on one side of the predetermined position X0 is pressed using a press holding tool 82 to fix the one side portion of the wire 15 to the horizontal workbench 81. While under such state, the other end of the wire 15 (the free end side which is not press held using the press holding tool 82), load F is applied to wind the wire, thereby the wire 15 is bent as shown in the figure.

As a result, the wire 15 is plastically deformed at approximately a maximum curvature within a range which does not rupture, hence, such state is analyzed and the parameter representing the easiness of bending of the wire 15 is obtained. Specifically, as shown in FIG. 4B, regarding a certain position Pw of the bent wire 15, an angle Φ (normal line angle) is detected which is formed between a straight line (normal line) H perpendicular to a tangent line of the wire 15 at the position Pw and a vertical axis Ys to the upper face of the horizontal workbench 81. Also, the length s at the position Pw is differentiated by the normal line angle Φ to obtain a differentiated value |ds/dΦ|, and this is defined as a radius of curvature r.

In this analysis, the bent state of the wire 15 from the vertical axis Ys to the position Pw is approximated as a circle, and the bent state is represented by the radius of curvature r of the approximated circle and the normal line angle Φ at the position Pw. The radius of curvature can be detected at any position of the bent wire 15, that is, the radius of curvature can be detected with respect to any normal line angle Φ from 0° to 90°. Therefore, by selecting the minimum radius of curvature rmin among the combinations of the detected normal line angles Φ and radius of curvatures, the radius of curvature (rmin) can be detected at the position which is the most bent due to load F applied for winding the wire around the object to be wrapped. As the bent state detecting position Pw for determining the cross-sectional shape of the winding core part 21, for example, a position giving the largest cross-sectional area of the winding core part 21 is selected which is determined as described in below based on the detection results. Alternatively, the position where the wire is most bent may be selected.

When the circumference shape of the cross section of the winding core part 21 where the wire 15 is wound around does not have a bent portion (arc portion) with smaller radius of curvature than this minimum radius of curvature, and also when the circumference shape is smoothly formed by a combination of arc portions with radius of curvature r (r≥rmin), the wire 15 can be wound around the winding core part 21 while being closely in contact with the winding core part 21. As a result, a gap is prevented from formed between the circumference face of the core member 21 and the wire 15, or the gap can be reduced.

Based on the parameter Φ representing the easiness of bending of the wire 15, r (rmin) detected as such, and the above-mentioned sizes L1 and L2 of the winding core part 21, the shape of the cross section of the winding core part 21 is determined, that is, the center positions, radii, and central angles of the first to third arcs A11 to A14, A21, A22, A31, and A32 are determined.

For example, the first arcs A11 to A14 each having the radius of curvature of r (r≥rmin) and the central angle Φ are arranged at four corners, and the second arcs A21 and A22 and the third arcs A31 and A32 having larger radius of curvature than the arcs are tangentially connected in sequence within a range of the size 2L1×2L2 of the winding core part 21, thereby the cross-sectional shape of the winding core part 21 as shown in FIG. 2A can be obtained. The shape which satisfies the above-mentioned condition is not limited to one shape, and in the case that there are several cross-sectional shapes which satisfy the above-mentioned conditions, for example, the shape with the largest area among these is selected.

Also, the cross-sectional shape of the winding core part (core member) 21 can be defined according to the conditions shown in FIG. 3. The shape shown in FIG. 3 is a shape that the first to third arcs A11 to A14, A21, A22, A31, and A32 are smoothly connected in sequence at the connecting points P1 to P8, as similar to the shape shown in FIG. 2A. In the case of the shape shown in FIG. 3, the first arcs A11 to A14 each having the radius of curvature R (R=r≥rmin) and a central angle Φ are arranged at four corners based on the parameter Φ and r (rmin) measured using a method shown in FIG. 4.

Also, in the shape (condition) shown in FIG. 3, the second arcs A21 and A22 and the third arcs A31 and A32 have the same central angle θ, and under such condition, the geometric characteristics satisfy the below relational formulae.

2θ+ϕ=90°

R₂−R=X/sin θ

R₃−R=Y/sin θ

X₃=L₁−R₃=L₁−R−Y/sin θ

X₃=X−Y/tan θ

Y₂=L₂−R₂=L₂−R−X/sin θ

Y₂=Y−X/tan θ Formula 3

Note that, in the above equations,
X and Y are the center coordinates of the first arc A₁₁,
Y₂ is the Y coordinate of the center of the second arc A₂₁,
X₃ is the X coordinate of the center of the third arc A₃₁,
R is a radius of the first arc A₁₁ and R=r,
R₂ is a radius of the second arc A₂₁,
R₃ is a radius of third arc A₃₁,
θ is ½ of the central angle of the second arc A₂₁ and the third arc A₃₁,
L₁ is ½ of the X axis direction length of the winding core part 21, and
L₂ is ½ of the Y axis direction length of the winding core part 21.

When these formulae are solved as simultaneous equations, the center coordinates (X,Y) of the first arc A11 give the following values.

$$X = \frac{{L}_{1} - R + ( \frac{1}{tan θ} - \frac{1}{sin θ} ) \cdot ( {L}_{2} - R )}{1 - {( \frac{1}{tan θ} - \frac{1}{sin θ} )}^{2}} \qquad [ Formula 4 ]$$

$$Y = \frac{{L}_{2} - R + ( \frac{1}{tan θ} - \frac{1}{sin θ} ) \cdot ( {L}_{1} - R )}{1 - {( \frac{1}{tan θ} - \frac{1}{sin θ} )}^{2}}$$

In other words, the cross section of the winding core part 21 according to the present disclosure is a shape in which the above-mentioned X and Y, that is, the below two formulae, give positive values.

$$\frac{{L}_{1} - R + ( \frac{1}{tan θ} - \frac{1}{sin θ} ) ( {L}_{2} - R )}{1 - {( \frac{1}{tan θ} - \frac{1}{sin θ} )}^{2}} , \qquad [ Formula 5 ]$$

$$\frac{{L}_{2} - R + ( \frac{1}{tan θ} - \frac{1}{sin θ} ) ( {L}_{1} - R )}{1 - {( \frac{1}{tan θ} - \frac{1}{sin θ} )}^{2}}$$

Also, based on these, a radius R2 of the second arc A21, a radius R3 of the third arc A31, the center coordinates (0,Y2) of the second arc A21, and the center coordinate (X3,0) of the third arc A31 are determined as described in below.

R₂=R+X/sin θ

R₃=R+Y/sin θ

X₃=L₁−R₃

Y₂=L₂−R₂ [Formula 6]

The cross section of the winding core part (core member) 21 of the drum core 20 according to the present disclosure may be such shape.

Back to FIG. 1A, the first flange 22 and the second flange 26 of the drum core 20 are the portions which are protruding out from the perpendicular plane (X-Y axis plane) along the winding axis direction (Z-axis direction) of the winding core part 21. The first flange 22 and the second flange 26 are arranged such that these are opposing to each other across the winding core part 21, and these flanges and the winding core part 21 are integrally formed.

The shapes of the first flange 22 and the second flange 26 are not particularly limited, and in the present embodiment, each of these is substantially a cuboid shape which includes a pair of side faces facing each other in X-axis direction, a pair of side faces facing each other in Y-axis direction, an outer end face in the winding axis direction (Z-axis direction), and an inner end face of the winding axis direction positioned at opposite side of the outer end face. That is, the first flange 22 and the second flange 26 are square shaped as a whole when viewed from Z-axis direction, and these are cuboid shape having thickness in Z-axis direction.

At the inner face of the first flange 22, a Z-axis direction upper end of the coil part 10 is positioned, and at the inner face of the second flange 26, a Z-axis direction lower end of the coil part 10 is positioned. Also, the outer end face of the second flange 26 is defined as the mounting face 28, and the pair of terminal electrodes 31 and 32 are installed to the mounting face 28. Also, at one of the side faces of the second flange 26, the wire connecting portions 38 and 38 are arranged where the first electrode 31 and the first lead 12 are connected to one of the wire connecting portions, and the second electrode 32 and the second lead 13 are connected to another one of the wire connecting portions.

As a magnetic material constituting the drum core 20, metals and a soft magnetic material such as ferrite and so on may be mentioned, however, it is not limited thereto.

The first electrode 31 and the second electrode 32 (these may be referred to as the terminal electrode 31 and the terminal electrode 32) are installed to the lower face (mounting face) 28 of the second flange 26 of the drum core 20, thereby the coil part 10 is electrically connected to an external circuit of the mounting substrate. The first electrode 31 is installed along the side edge at one side of the X-axis direction of the second flange 26, and the second electrode 32 is installed along the side edge at another side of the X-axis direction of the second flange 26. The first electrode 31 is connected to the first lead 12 of the wire 15 constituting the coil part 10, and the second electrode 32 is connected to the second lead 13 of the wire 15 constituting the coil part 10.

The terminal electrodes 31 and 32 are formed by bending both end parts of the metal electrode member of a plate shape extending in Y-axis direction, in a predetermined length up in Z-axis direction. Each of the terminal electrodes 31 and 32 includes a main portion 33 at the center portion, and bent portions 34 and 35 are arranged in a way that these are opposing the both end parts across the main portion 33. The distance between the bent portion opposing each other (that is, the Y-axis direction length of the main portion 33) is approximately the same as the Y-axis direction length of the second flange 26 of the drum core 20. The terminal electrodes 31 and 32 are fitted and installed to the second flange 26 so that the second flange 26 of the drum core 20 is held along the Y-axis direction by the bent portions 34 and 35 opposing each other. The terminal electrodes 31 and 32 may be bonded to the second flange 26, for example, by using an adhesive and so on; however, a method of mounting the terminal electrodes 31 and 32 is not limited thereto.

One of the bent portions 34 and 35 of the terminal electrodes 31 and 32 is formed to the wire connecting portions 38 and 38 which connect with the first lead 12 and the second lead 13 of the wire 15 constituting the coil part 10. At the outside surface of the bent portions 34 and 34 bonded to the side face of the second flange 26, the end parts 12e and 13e of the first lead 12 and the second lead 13 of the wire 15 constituting the coil 10 are arranged, and for example, the end parts 12e and 13e are bonded using a laser welding and so on.

By performing a laser welding (at a temperature of 1000° C. or higher), the terminal electrodes 31 and 32 and the leads 12 and 13 of the wire 15 can be connected at a temperature higher than a temperature for forming a solder filet (230 to 280° C.), and the wire 15 can be connected securely and firmly. Note that, the leads 12 and 13 of the wire 15 can be bonded with the terminal electrodes 31 and 32 using methods other than a laser welding.

For example, the terminal electrodes 31 and 32 are made using a conductive metal plate such as tough pitch steel, phosphor bronze, brass, iron, nickel, and so on.

The encapsulated resin 40 are arranged around the coil part 10, and the space between the first flange 22 and the second flange 26 of the drum core 20 is filled with the encapsulated resin. By arranging the encapsulated resin 40 around the coil part 10, the coil part 10 can be effectively protected, and also short circuit malfunction and so on can be suppressed. The encapsulated resin 40 may be made using a magnetic material containing resin. By using the magnetic material containing resin, the encapsulated resin 40 works as a pathway of a magnetic field, and a magnetic property of the coil device 1 is enhanced. The magnetic material included in the encapsulated resin 40 is not particularly limited, and the magnetic powder which is the same as the magnetic material constituting the drum core 20, or any other magnetic powder may be mentioned.

Next, a method of producing the coil component 1 is described.

First, the drum core 20 shown in FIG. 1B is molded. A method of molding the drum core 20 is not particularly limited, and a compression molding, CIM (Ceramic Injection Molding), MIM (Metal Injection Molding), and so on may be mentioned. After molding is performed, firing is performed to form a fired body.

Next, the terminal electrodes 31 and 32 are installed to the second flange 26 of the drum core 20. When the terminal electrodes 31 and 32 are installed and fixed to the second flange 26, an adhesive may be placed between the second flange 26 and the terminal electrodes 31 and 32. The terminal electrodes 31 and 32 can be easily formed from one plate of metal (for example, copper plate) using a punch molding and bend molding.

After the terminal electrodes 31 and 32 are installed to the drum core 20, or prior to that, the coil part 10 is formed by winding the wire 15 around the core member 21 of the drum core 20. An auto-winding machine is used for winding the wire to apply a predetermined tension to the wire 15, and the wire 15 is wound around the winding core part 21 of the drum core 20.

At this time, tension is applied to the wire 15 so that a predetermined load F set in advance acts on the wire 15 in a bending direction. As mentioned in above, the winding core part 21 of the drum core 20 according to the present disclosure is formed to have the cross-sectional shape of the winding core part 21 such that the wire and the circumference face of the winding core part 21 of the drum core are in close contact at least when the wire 15 is wound by applying a predetermined tension (load F). Therefore, by winding the wire 15 by such predetermined tension (load F), the gap between the wire 15 and the winding core part 21 is prevented from forming, and the wire 15 can be wound around the winding core part 21 without forming space around the winding core part 21.

After the coil part 10 is formed to the winding core part 21, the first lead 12 and the second lead 13, which are both ends of the wire 15, are arranged at the outside of one of the bent portions 34 and 34 of the first electrode 31 and the second electrode 32 arranged at the side face of the second flange 26 of the drum core 20. Then, the leads 12 and 13 are bonded with the terminal electrodes 31 and 32, for example, using laser welding.

Lastly, a molten resin is discharged, for example, by using a dispenser to the space between the first flange 22 and the second flange 26 of the drum core 20, and the encapsulated resin 40 is formed around the coil part 10.

In the coil component 1 of the present disclosure, the cross-sectional shape of the winding core part (core member) 21 of the drum core 20 is shaped so that the wire 15 can be in close contact with the winding core part 21. Therefore, the gap is prevented from forming between the wire wound part 11 where the wire 15 is wound and the winding core part (core member) 21 of the drum core 20. Alternatively, even if the gap is formed, it can be reduced. As a result, this can prevent decrease of a permeability caused by the gap and also prevents inductance decrease. Also, by preventing the inductance decrease, Q property can be enhanced/improved. Thus, as the coil component 1 of the present disclosure, a coil component with large inductance and high performance can be obtained without increasing the size of the coil component.

Also, in the case of obtaining the coil component having the same property, the size of the coil component can be made smaller. The coil component according to the present embodiment can be compact such that, for example, a maximum length in plane direction may be 5 mm or less, 3 mm or less, or 0.5 mm or less; and a height may be 5 mm or less, 3 mm or less, or 0.5 mm or less.

Also, by reducing the gap between the wire wound part 11 and the winding core part 21, the permeability of the gap portion (vacuum permeability) impacting a designed permeability of the coil component can be reduced. The designed permeability is a permeability of the coil component designed based on the coil size and the permeability of the coil. As a result, the coil component having the permeability (inductance) as designed or close to the designed permeability (inductance) can be produced easily.

Also, regarding the coil component 1 of the present disclosure, since the wire 15 can be wound around the winding core part 21 of the drum core 20 while being in close contact with the winding core part 21, the wire 15 is prevented from shifting, and the shape of the coil part 10 is stabilized. Furthermore, fluctuation of inductance (L) can be prevented and reduced.

### EXAMPLES

Examples of a coil component according to the present disclosure are described. A size of the coil component according to the present disclosure in which a winding core part 21 having the above-mentioned cross-sectional shape had the same size as two coil components of comparative examples having the winding core part 21 with different the cross-sectional shapes. The coil components were produced so that the winding core part of each shape had maximum area, and the property and so on were compared.

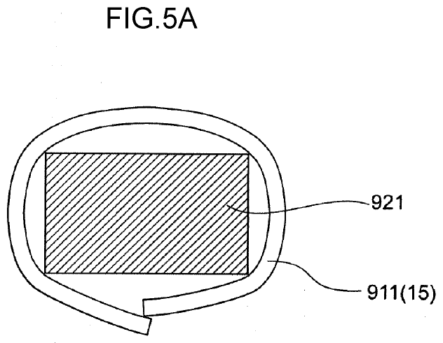

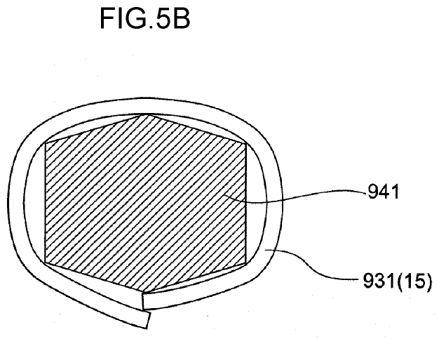

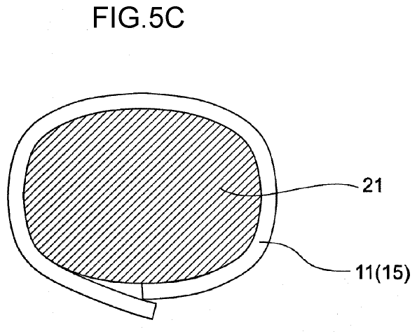

As shown in FIG. 5A, the coil component of a first comparative example (Cex.1) was a coil component in which a wire wound part 911 was formed around a winding core part (core member) 921 having a cross section of a rectangle shape. As shown in FIG. 5B, a coil component of a second comparative example (Cex.2) was a coil component in which a wire wound part 931 was formed around a winding core part (core member) 941 having a cross section of a hexagonal shape. As shown in FIG. 5C, an example 1 (Ex.1) of a coil component according to the present disclosure was a coil component in which a wire wound part 11 was formed around the winding core part having a circumference shape that a cross section had eight arcs of three different types which were tangentially connected in sequence. The coil components shown in FIG. 5A to FIG. 5C all had a planar shape of 2.5 mm×2.00 mm, a height of 1.00 mm, a volume of 5.00 mm³, a flange height of 0.2 mm, a number of turns of wire of 5.5 turns.

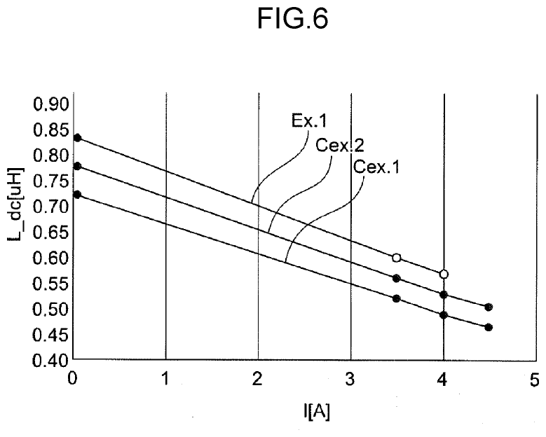

Then, for each coil component, a cross section area of the core member, a gap formed between the coil part and the winding core part, and DC superimposition characteristics were measured. Results of measurement are shown in Table 1 and FIG. 6.

TABLE 1

| | Core member | | Starting | | L0 |
|---|---|---|---|---|---|
| | cross | | property | | increased |
| | section area | Gap | (L0) | I_sat30% | rate |
| | (mm²) | (mm²) | (μH) | (A) | (%) |
| Cex. 1 | 1.123 | 0.403 | 0.72 | 3.09 | 0 |
| Cex. 2 | 1.3007 | 0.183 | 0.78 | 3.05 | 7.9 |
| Ex. 1 | 1.44 | 0.011 | 0.84 | 3.05 | 15.9 |

As obvious from Table 1, a plane size of each of the coil components was the same, however, in regards with the coil component according the example 1 (Ex.1), the core member (winding core part) had a larger cross-sectional area (core member cross section area) compared to the coil component of the comparative example 1 (Cex.1) where the wire 15 was wound around the winding core part having a cross section of rectangle shape and also compared to the coil component of the comparative example 2 (Cex.2) where the wire 15 was wound around the winding core part having a cross section of a hexagonal shape.

Inductance was expected to increase along with the increase in the cross-sectional area of the core member, and as obvious from the inductance value of L0 of the starting condition (condition that DC current had not been applied) shown in Table 1 and a graph representing DC superimposition characteristics of FIG. 6, the coil component according to the present disclosure did actually exhibit increased inductance by 15% or more (at starting condition, it is 15.9%) compared to the coil component of the comparative example 1. Also, the coil component according to the present disclosure exhibited increased inductance by 7% or more (at starting condition, it was 7.4% (=115.9/107.9)) compared to the coil component of the comparative example 2. On the other hand, regarding a maximum current I_sat30% where the inductance was −30%, the coil component according to the present disclosure exhibited approximately the same value as those of the comparative examples 1 and 2; and it was verified that the coil component according to the present disclosure did not show decrease in the characteristic of saturation current.

Also, as it is obvious from Table 1, the gap formed between the coil part and the winding core part was significantly smaller in the coil component according to the present disclosure compared to the coil components of the comparative example 1 and the comparative example 2.

The present disclosure is not limited to the above-mentioned embodiment, and various arbitrary suitable modifications are possible.

For example, in the above-mentioned embodiment, the wire was wound around the winding core part (core member) of the drum core, however, the member (core) where the wire was wound around does not necessarily have to be the drum core. For example, a rod-shaped core without a flange portion, a so-called E-shaped core, PQ core, or so may be used. Also, regarding the toroidal core, by making the cross-sectional shape of the toroidal core according to the present disclosure, the same effects can be attained. The present disclosure can be used for such objects.

Also, the shape of the core member is not limited to a shape having a cross section in which eight arcs of three different types are connected tangentially in sequence. As long as the cross section of the core member has at least three first arcs with predetermined radii and central angles enabling the wire to be in close contact with the core member, the cross-sectional shape of the core member can have the shape that the wire is wound to the core member while being in close contact with the core member. The core member according to the present disclosure may be any shape as such.

For example, when the three first arcs are sequentially connected using straight lines which tangentially connect with the arcs, a shape which is roughly a triangle shape with rounded corners are formed. Even when the cross-sectional shape of the core member is formed in a such tringle shape, it is possible to wind the wire along the circumference of the core member without forming the gap.

Also as shown in FIG. 2B, the core member may be a core member 221 having roughly a rectangle cross section with arc-shaped corners 223 as four corners to the rectangle shape (imaginary rectangle) 222. In this cross-section shape, the arc-shaped corner 223 corresponds to the first arc according to the present disclosure, and the four first arcs are connected by straight connecting lines. For such core member 221, by forming the arc-shaped corner 223 as an arc which are formed by taking into consideration of the easiness of bending of the wire, that is, by forming as an arc having predetermined radius and predetermined central angle so that the wire and the core member can contact closely, the wire 15 are wound around the core member 221 while the wire is in close contact with the core member 221 at the arc shaped corner 223. As a result, the gap between the wire wound part 211 and the core member 221 can be reduced.

Regarding the embodiment shown in FIG. 2B, at the straight-line portions of the cross-sectional circumference of the core member 221, particularly at the straight line portions of long sides of the imaginary rectangle 222, a small space 218 was formed between the wire wound inner circumference 217 and the core member 221. However, this space 218 is smaller than that formed to a usual embodiment (such as the embodiment shown in FIG. 5A) where the wire 15 was wound to a flat plane (the plane that the cross section is straight line), thus improved inductance can be attained even in the case of the embodiment shown in FIG. 2B. For the arc-shaped corner 223, the radius can be increased to ½ the size of the width Ls in a short direction of the imaginary rectangle 222.

Also, the core member may be a core member 321 shown in FIG. 2C. The core member 321 had a shape that a portion which corresponds to a long side of the imaginary rectangle was protruding out from the core member 221 shown in FIG. 2B. That is, the cross section of the core member 321 had four corners formed by four arc-shaped corners 323 which corresponds to the first arcs according to the present disclosure, and portion of the longitudinal side of the imaginary rectangle 322 was raised in a triangular shape due to the slanted sides 325 and 325.

In such shape, a raised portion 324 was formed where the wire 15 was detached (the space 218 of FIG. 2B) from the circumference of the core member of the longitudinal side of the imaginary rectangle shape 322. Thus, the space 318 formed between the wire wound inner circumference 317 and the core member 321 can be smaller than the space 218 of the wire wound part 211 shown in FIG. 2B, hence inductance can be increased. Here, it is obvious that the cross-sectional shape of the core member 321 shown in FIG. 2C was closer to the winding core part 21 shown in FIG. 2A of which the cross-sectional shape had eight arcs of three different types are tangentially connected in sequence. Note that, regarding the core member 321, the radius of the arc-shaped corner 323 can be increased to ½ of the width Ls of the short direction of the imaginary rectangle 322.

Also, in the core members 221 and 331 shown in FIG. 2B and FIG. 2C, the connecting lines which connect the arc-shaped corners 223 and 323 of the corner portion may be a curved line, a combination of two or more curved lines, a combination of three or more curved lines, a combination of any numbers of straight line and curved line, and so on. In any case, when the curved line was used, a curved line having larger radius of curvature than a radius of curvature of the arc-shaped corners 223 and 323 may be used since the gap between the core members 221 and 321 and the wire wound parts 211 and 311 can be removed or reduced.

Also, when the straight line was used, preferably the straight line may be tangentially connected to another straight line and curved lines. However, the straight line does not necessarily have to be tangentially connected to another straight line and the curved line, as long as the straight line is connected to another straight line and the curved lines in a way that the gap between the wire and the core member is reduced.

Also, in the coil component of the present disclosure, the wire does not necessarily have to be wound directly to the winding core part, and for example, the wire can be wound to a bobbin. In such case, a cross-sectional circumference shape of the bobbin may be shaped according to the present disclosure as mentioned in above. Also, in some embodiments, the members such as the magnetic core and so on which are installed inside the bobbin is shaped according to the present disclosure as mentioned in above.

Also, the present disclosure is not limited to the embodiment that cross sections at any position along the longitudinal direction (Z-axis direction, winding axis direction) of the core member (winding core part) 21 are the same. The circumference face of the core member 21 may be slanted along the longitudinal direction of the core member 21, or a step may be formed. As long as the cross section has a shape according to the present disclosure at some positions along the longitudinal direction, or at any position with different cross section shapes, the improvement of the properties of the coil component can be attained, hence the effect of the present disclosure can be achieved.

Also, the present disclosure is not limited to the configuration of winding the wire around the winding core part. The present disclosure can be suitably used in a configuration in which arbitrary electronic component element is arranged in close contact around the core member for installation.

As it can be understood from the above description, followings are disclosed in the present specification.

### Supplementary Note 1

A coil component including:
a core member; and
a wire wound around the core member,
wherein a cross section of the core member perpendicular to a winding axis of the wire wound around the core member has a circumference shape including at least three first arcs and connecting lines connecting the at least three first arcs adjacent to each other, and
each of the at least three first arcs has a predetermined radius and a predetermined central angle for closely contacting the wire and the core member

Regarding the coil component having such configuration, the cross section of the core member has the circumference shape including at least three of the first arcs each having a predetermined radius and a predetermined central angle allowing the wire to closely contact with the core member, and connecting lines which connect the first arcs adjacent to each other. Thus, the wire can be wound around the core member without forming a gap between the wire and the core member, or the gap between the wire and the core member can be reduced. As a result, decrease in inductance caused by the gap formed between a wire wound part and the core member can be reduced, hence a coil component having large inductance for a size of the coil component can be obtained, that is, a high-performance coil component can be obtained.

In the coil component according to the present disclosure, for example, when all of the first arcs and all of the connecting lines have the same center and the same radius, the circumference shape of the core member is a perfect circle, however, the coil component of the present disclosure does not include such embodiment. That is, in the coil component of the present disclosure, the centers and the radii of the first arcs and the connecting lines are not all the same.

### Supplementary Note 2

The coil component according to Supplementary note 1, wherein each of the connecting lines is made of one or more straight lines, one or more curved lines, or a combination of one or more straight lines and one or more curved lines, and the curved lines have a radius of curvature larger than radii of the at least three first arcs adjacent to each other.

### Supplementary Note 3

The coil component according to Supplementary note 1 or 2, wherein the at least three first arcs are tangentially connected to the connecting lines.

### Supplementary Note 4

The coil component according to any one of Supplementary notes 1 to 3, wherein the at least three first arcs are four first arcs, and the cross section of the core member is roughly a rectangular shape in which the four first arcs are arranged at four corners of the rectangular shape.

### Supplementary Note 5

The coil component according to any one of Supplementary notes 1, 2, or 4, wherein at least one of the connecting lines connecting the at least three first arcs have a shape that a combination of the straight lines or the one or more curved lines are protruding outwards.

### Supplementary Note 6

The coil component according to any one of Supplementary notes 1 to 5, wherein the connecting lines include second arcs in pairs which are opposing to each other along one axis of two axes perpendicular to each other, and third arcs in pairs which are opposing to each other along an other axis of the two axes perpendicular to each other, in which
each of the at least three first arcs may be arranged between one of the second arcs and one of the third arcs,
a direction extending to connect a mid-point of one of the at least three first arcs and a center point of one of the at least three first arcs forms 45° with each of the two axes perpendicular to each other, and
the at least three first arcs are tangentially connected to the second arcs and the third arcs.

### Supplementary Note 7

The coil component according to Supplementary note 6, wherein the cross section of the core member has a shape in which two formulae shown in below give positive solutions.

$$\frac{{L}_{1} - R + ( \frac{1}{tan θ} - \frac{1}{sin θ} ) ( {L}_{2} - R )}{1 - {( \frac{1}{tan θ} - \frac{1}{sin θ} )}^{2}} , \qquad [ Formula 1 ]$$

$$\frac{{L}_{2} - R + ( \frac{1}{tan θ} - \frac{1}{sin θ} ) ( {L}_{1} - R )}{1 - {( \frac{1}{tan θ} - \frac{1}{sin θ} )}^{2}}$$

where
2L₁ is a length along one axis of the two axes perpendicular to each other in the shape of the cross section of the core member,
2L₂ is a length along an other axis of the two axes perpendicular to each other in the shape of the cross section of the core member,
R is a radius of one of the at least three first arcs, and
2θ is a central angle of one of the second arcs and one of the third arcs.

### Supplementary Note 8

A core member, wherein
the core member has a shape that a circumference of a cross section of the core member includes:
second arcs in pairs which are opposite to each other along one axis of two axes perpendicular to each other,
third arcs in pairs which are opposite to each other along an other axis of the two axes perpendicular to each other, and
four of first arcs which each of these is arranged between one of the second arcs and one of the third arcs, in which a direction extending to connect a mid-point and a center point of each of the first arcs forms 45° with each axis of the two axes perpendicular to each other, and the first arcs are tangentially connected respectively to the second arcs and to the third arcs.

### Supplementary Note 9

The core member according to Supplementary note 8, wherein the cross section of the core member has a shape in which two formulae shown in below give positive solutions,

$$\frac{{L}_{1} - R + ( \frac{1}{tan θ} - \frac{1}{sin θ} ) ( {L}_{2} - R )}{1 - {( \frac{1}{tan θ} - \frac{1}{sin θ} )}^{2}} , \qquad [ Formula 2 ]$$

$$\frac{{L}_{2} - R + ( \frac{1}{tan θ} - \frac{1}{sin θ} ) ( {L}_{1} - R )}{1 - {( \frac{1}{tan θ} - \frac{1}{sin θ} )}^{2}}$$

where
2L₁ is a length along one axis of the two axes perpendicular to each other in the shape of the cross section of the core member,
2L₂ is a length along an other axis of the two axes perpendicular to each other in the shape of the cross section of the core member,
R is a radius of one of the first arcs, and
2θ is a central angle of one of the second arcs and one of the third arcs.

### Supplementary Note 10

A core component, including:
a core member according to Supplementary note 8 or 9; and a flange portion installed to both sides of the core member in an axis direction perpendicular to a cross section of the core member.

### Supplementary Note 11

An electronic component including the core member according to Supplementary note 8 or 9.

### REFERENCE SIGNS LIST

1 . . . Coil component
10 . . . Coil part
11, 211, 311, 911, 931 . . . Wound wire part
12 . . . First Wire
13 . . . Second wire
12e,13e . . . Lead end part
15 . . . Wire
17, 217, 317 . . . Wound wire inner circumference
218, 318 . . . Space
20 . . . Drum core
21, 221, 321, 921, 941 . . . Winding core part (Core member)
22 . . . First flange (brim)
26 . . . Second flange (brim)
28 . . . Mounting face
222, 322 . . . Imaginary rectangle
223, 323 . . . Arc-shaped corner
324 . . . Raised portion
325 . . . Slanted side
31 . . . First electrode (terminal electrode)
32 . . . Second electrode (terminal electrode)
33 . . . Main portion
34, 35 . . . Bent portion
38 . . . Connecting portion
40 . . . Encapsulated resin
81 . . . Horizontal workbench
82 . . . Press holding member
P1 to P8 . . . Connecting point
A11 to A14 . . . First arc
A21, A22 . . . Second arc
A31, A32 . . . Third arc
C11 to C14 . . . Center of first arc
C21, C22 . . . Center of second arc
C31, C32 . . . Center of third arc

What is claimed is:

1. A coil component comprising:
a core member; and
a wire wound around the core member,
wherein a cross section of the core member perpendicular to a winding axis of the wire wound around the core member has a circumference shape comprising at least three first arcs and connecting lines connecting the at least three first arcs adjacent to each other, and
each of the at least three first arcs has a predetermined radius and a predetermined central angle for closely contacting the wire and the core member.

2. The coil component according to claim 1, wherein
each of the connecting lines is made of one or more straight lines, one or more curved lines, or a combination of one or more straight lines and one or more curved lines, and each of the curved lines has a radius of curvature larger than radii of the at least three first arcs adjacent to each other.

3. The coil component according to claim 1, wherein the at least three first arcs are tangentially connected to the connecting lines.

4. The coil component according to claim 1, wherein the at least three first arcs are four first arcs, and the cross section of the core member is roughly a rectangular shape in which the four first arcs are arranged at four corners of the rectangular shape.

5. The coil component according to claim 2, wherein at least one of the connecting lines connecting the at least three first arcs have a shape that a combination of the straight lines or the one or more curved lines is protruding outwards.

6. The coil component according to claim 1, wherein the connecting lines comprise second arcs in pairs opposite to each other along one axis of two axes perpendicular to each other, and third arcs in pairs opposite to each other along an other axis of the two axes perpendicular to each other, in which
each of the at least three first arcs is arranged between one of the second arcs and one of the third arcs,
a direction extending to connect a mid-point of one of the at least three first arcs and a center point of one of the at least three first arcs forms 45° with each of the two axes perpendicular to each other, and
the at least three first arcs are tangentially connected to the second arcs and the third arcs.

7. The coil component according to claim 6, wherein the cross section of the core member has a shape in which two formulae shown in below give positive solutions,
$$\frac{{L}_{1} - R + ( \frac{1}{tan θ} - \frac{1}{sin θ} ) ( {L}_{2} - R )}{1 - {( \frac{1}{tan θ} - \frac{1}{sin θ} )}^{2}} ,$$
$$\frac{{L}_{2} - R + ( \frac{1}{tan θ} - \frac{1}{sin θ} ) ( {L}_{1} - R )}{1 - {( \frac{1}{tan θ} - \frac{1}{sin θ} )}^{2}}$$
where
2L₁ is a length along one axis of the two axes perpendicular to each other in the shape of the cross section of the core member,
2L₂ is a length along an other axis of the two axes perpendicular to each other in the shape of the cross section of the core member,
R is a radius of one of the at least three first arcs, and
2θ is a central angle of one of the second arcs and one of the third arcs.

8. A core member, wherein
the core member has a shape that a circumference of a cross section of the core member includes:
second arcs in pairs opposite to each other along one axis of two axes perpendicular to each other,
third arcs in pairs opposite to each other along an other axis of the two axes perpendicular to each other, and
four of first arcs each of which is arranged between one of the second arcs and one of the third arcs, in which a direction extending to connect a mid-point and a center point of each of the first arcs forms 45° with each axis of the two axes perpendicular to each other, and the first arcs are tangentially connected respectively to the second arcs and to the third arcs.

9. The core member according to claim 8, wherein the cross section of the core member has a shape in which below two formulae give positive solutions,
$$\frac{{L}_{1} - R + ( \frac{1}{tan θ} - \frac{1}{sin θ} ) ( {L}_{2} - R )}{1 - {( \frac{1}{tan θ} - \frac{1}{sin θ} )}^{2}} ,$$
$$\frac{{L}_{2} - R + ( \frac{1}{tan θ} - \frac{1}{sin θ} ) ( {L}_{1} - R )}{1 - {( \frac{1}{tan θ} - \frac{1}{sin θ} )}^{2}}$$
where
2L₁ is a length along one axis of the two axes perpendicular to each other in the shape of the cross section of the core member,
2L₂ is a length along an other axis of the two axes perpendicular to each other in the shape of the cross section of the core member,
R is a radius of one of the first arcs, and
2θ is a central angle of one of the second arcs and one of the third arcs.

10. A core component, comprising:
a core member according to claim 8; and
a flange portion installed to both sides of the core member in an axis direction perpendicular to a cross section of the core member.

11. An electronic component comprising the core member according to claim 8.
